(19) United States
(12) Patent Application Publication
(10) Pub. No.: US 2025/0200038 A1
(43) Pub. Date: Jun. 19, 2025

(54) OPTIMIZED EPHEMERAL QUERY EXECUTION IN A DISTRIBUTED IN-MEMORY DATABASE

(71) Applicant: WORKDAY, INC., Pleasanton, CA (US)

(72) Inventors: Shivender DEVARAKONDA, Dublin, CA (US); Karthik RAJAGOPAL, San Carlos, CA (US); Seema GUPTA, Fremont, CA (US)

(21) Appl. No.: 18/538,084

(22) Filed: Dec. 13, 2023

(51) Int. Cl. G06F 16/2453

(52) U.S. Cl. CPC G06F 16/24542

(57) ABSTRACT

In some implementations, the techniques described herein relate to a method including: receiving, by a processor, a query from a client device; distributing, by the processor, the query to a plurality of shards; receiving, by the processor, a plurality of array provider data structures from the plurality of shards, a given array provider data structure identifying responsive identifiers from a corresponding shard; materializing, by the processor, the plurality of array provider data structures; persisting, by the processor, a portion of responsive data on disk while materializing the plurality of array provider data structures; merging, by the processor, data stored on the disk; and returning, by the processor, a result set based on the data to the client device.

### BACKGROUND

The application relates to the field of databases and, in particular, optimizing distributed operations on in-memory database technologies. Many in-memory databases are distributed among many machines, either real or virtual. In these systems, when a query is executed, each machine generates a result set which is stored and transmitted to a central engine for aggregation. This approach results in significant data storage and duplication due to the distributed nature of the processing.

### BRIEF DESCRIPTION OF THE DRAWINGS

FIG. 1 is a block diagram of a database system according to some of the disclosed embodiments.

FIG. 2 is a block diagram illustrating a distributed in-memory database according to some of the disclosed embodiments.

FIG. 3 is a block diagram illustrating a system for processing distributed queries according to some of the disclosed embodiments.

FIG. 4 is a flow diagram illustrating a method for performing lazy materialization of columnar data when executing a query according to some of the disclosed embodiments.

FIG. 5 is a flow diagram illustrating a method for materializing a query result based on array providers according to some of the disclosed embodiments.

FIG. 6 is a block diagram of a computing device according to some embodiments of the disclosure.

### DETAILED DESCRIPTION

In some implementations, the techniques described herein relate to a method including: receiving, by a processor, a query from a client device; distributing, by the processor, the query to a plurality of shards; receiving, by the processor, a plurality of array provider data structures from the plurality of shards, a given array provider data structure identifying responsive identifiers from a corresponding shard; materializing, by the processor, the plurality of array provider data structures; persisting, by the processor, a portion of responsive data on disk while materializing the plurality of array provider data structures; merging, by the processor, data stored on the disk; and returning, by the processor, a result set based on the data to the client device.

In some implementations, the techniques described herein relate to a method, wherein the given array provider data structure stores an array of responsive record identifiers.

In some implementations, the techniques described herein relate to a method, wherein the given array provider data structure supports at least one operation on the array of responsive record identifiers.

In some implementations, the techniques described herein relate to a method, wherein the given array provider data structure includes one of a dimension-backed array provider or a measure-backed array provider.

In some implementations, the techniques described herein relate to a method, wherein persisting a portion of responsive data on disk while materializing the plurality of array provider data structures includes: monitoring, by the processor, memory usage while receiving the responsive data; detecting, by the processor, that an amount of used memory is at or exceeds a threshold; and copying, by the processor, the responsive data from a queue to a persistent storage device.

In some implementations, the techniques described herein relate to a method, further including limiting a concurrency of incoming data from the plurality of shards while copying the responsive data.

In some implementations, the techniques described herein relate to a method, wherein copying the responsive data includes persisting the responsive data as on disk provider data structures.

In some implementations, the techniques described herein relate to a non-transitory computer-readable storage medium for tangibly storing computer program instructions capable of being executed by a processor, the computer program instructions defining steps of: receiving, by the processor, a query from a client device; distributing, by the processor, the query to a plurality of shards; receiving, by the processor, a plurality of array provider data structures from the plurality of shards, a given array provider data structure identifying responsive identifiers from a corresponding shard; materializing, by the processor, the plurality of array provider data structures; persisting, by the processor, a portion of responsive data on disk while materializing the plurality of array provider data structures; merging, by the processor, data stored on the disk; and returning, by the processor, a result set based on the data to the client device.

In some implementations, the techniques described herein relate to a non-transitory computer-readable storage medium, wherein the given array provider data structure stores an array of responsive record identifiers.

In some implementations, the techniques described herein relate to a non-transitory computer-readable storage medium, wherein the given array provider data structure supports at least one operation on the array of responsive record identifiers.

In some implementations, the techniques described herein relate to a non-transitory computer-readable storage medium, wherein the given array provider data structure includes one of a dimension-backed array provider or a measure-backed array provider.

In some implementations, the techniques described herein relate to a non-transitory computer-readable storage medium, wherein persisting a portion of responsive data on disk while materializing the plurality of array provider data structures includes: monitoring, by the processor, memory usage while receiving the responsive data; detecting, by the processor, that an amount of used memory is at or exceeds a threshold; and copying, by the processor, the responsive data from a queue to a persistent storage device.

In some implementations, the techniques described herein relate to a non-transitory computer-readable storage medium, further including limiting a concurrency of incoming data from the plurality of shards while copying the responsive data.

In some implementations, the techniques described herein relate to a non-transitory computer-readable storage medium, wherein copying the responsive data includes persisting the responsive data as on disk provider data structures.

In some implementations, the techniques described herein relate to a device including: a processor configured to receive a query from a client device; distribute the query to a plurality of shards; receive a plurality of array provider data structures from the plurality of shards, a given array provider data structure identifying responsive identifiers from a corresponding shard; materialize the plurality of array provider data structures; persist a portion of responsive data on disk while materializing the plurality of array provider data structures; merge data stored on the disk; and return a result set based on the data to the client device.

In some implementations, the techniques described herein relate to a device, wherein the given array provider data structure stores an array of responsive record identifiers and supports at least one operation on the array of responsive record identifiers.

In some implementations, the techniques described herein relate to a device, wherein the given array provider data structure includes one of a dimension-backed array provider or a measure-backed array provider.

In some implementations, the techniques described herein relate to a device, wherein persisting a portion of responsive data on disk while materializing the plurality of array provider data structures includes: monitoring, by the processor, memory usage while receiving the responsive data; detecting, by the processor, that an amount of used memory is at or exceeds a threshold; and copying, by the processor, the responsive data from a queue to a persistent storage device.

In some implementations, the techniques described herein relate to a device, further including limiting a concurrency of incoming data from the plurality of shards while copying the responsive data.

In some implementations, the techniques described herein relate to a device, wherein copying the responsive data includes persisting the responsive data as on disk provider data structures.

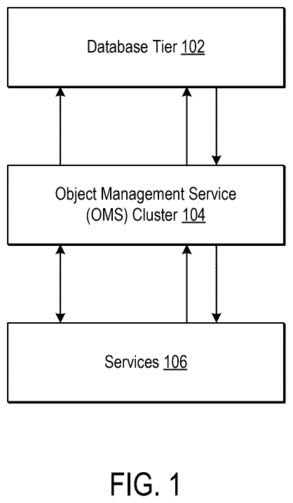

FIG. 1 is a block diagram of a database system according to some of the disclosed embodiments.

In the illustrated system, services 106 communicate with an object management service cluster (OMS 104). The OMS 104, in turn, communicates with a database 102.

In some implementations, database 102 may comprise a persistent store of data for use by the system. For example, database 102 may comprise a relational database management system or similar type of persistent storage technology. The specific underlying technology of database 102 is not limited. Indeed, any persistent storage technology may be used, and relational databases are used solely as an example. In some implementations, the database 102 may comprise multiple databases forming a storage architecture for persistent storage of data. For example, database 102 may include a relational database for transactional data, a NoSQL database for document storage, a key-value store for session data or other highly used data, as well as any other persistent technology. Further, in some implementations, the database 102 may also include volatile storage technologies in combination with persistent storage technologies. Ultimately, database 102 acts as a canonical source of data for the system.

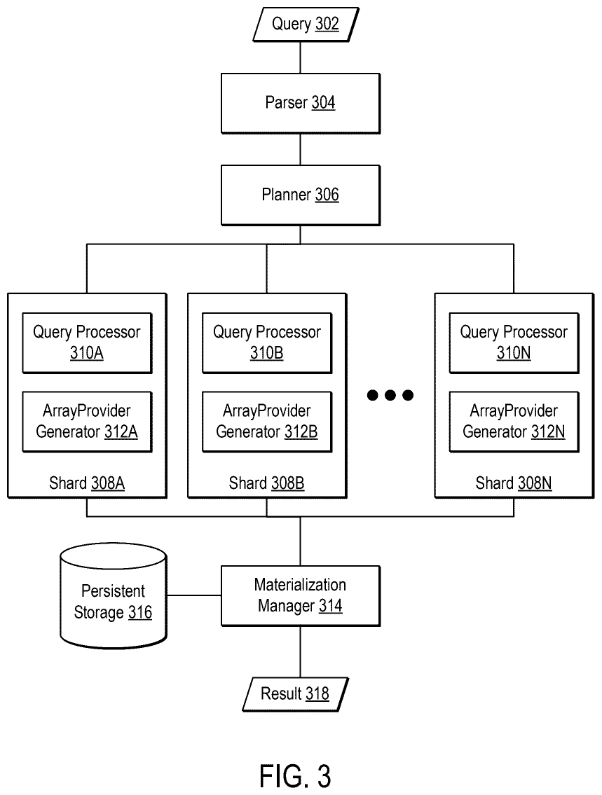

OMS 104, on the other hand, comprises an in-memory database. In some implementations, an in-memory database refers to a database technology that stores its data in volatile memory of one or more computing devices. In some implementations, as discussed more herein, OMS 104 may comprise a distributed, in-memory database. In this implementation, OMS 104 may comprise a plurality of real or virtual machines that operate to provide an in-memory database based on the data stored in database 102. In some implementations, the machines implementing OMS 104 may store subsets of the data stored in database 102. For example, database 102 may store a table having one million rows of data. During startup, OMS 104 may read these one million rows of data and provision one or more machines to store a partition or shard of the data. For example, OMS 104 may query the database 102 to determine a size of the data and then compute the number of machines needed to store the data in memory. As another example, OMS 104 may determine the size of data stored in the database 102 and determine the number of machines based on the memory sizes of the machines. In these implementations, OMS 104 is configured to store the entire contents or a significant portion of database 102 in volatile memory (for example, random access memory). As such, OMS 104 must determine the number of machines needed to reliably store the size of data stored in database 102. Returning to the previous example, OMS 104 may partition the one million rows of data in the table to ten machines storing one hundred thousand records each. Additional detail on the cluster nodes of OMS 104 are provided in the description of FIG. 3 and are not repeated herein.

As illustrated, services 106 interact primarily and in some implementations exclusively with OMS 104. Services 106 may comprise computing devices and/or software for accessing data stored in OMS 104. In some implementations, OMS 104 exposes an endpoint such as a network endpoint for receiving requests for data from services 106. In some implementations, services 106 may transmit structured query language (SQL) statements to OMS 104 for execution on the clustered databases. In other implementations, services 106 may transmit other forms of requests for data which OMS 104 converts into SQL statements.

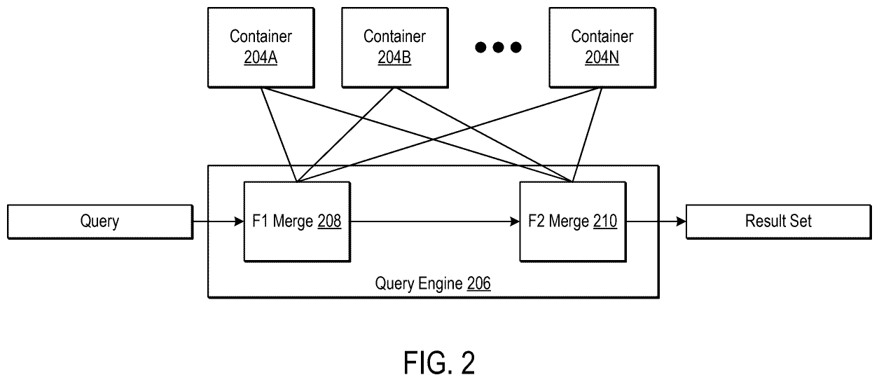

FIG. 2 is a block diagram illustrating a distributed in-memory database according to some of the disclosed embodiments.

In the illustrated figure, an OMS cluster is depicted as including a plurality of containers, including container 204A, container 204B, and container 204N. As discussed, data may be partitioned based on the size of the data to be distributed in memory across the cluster. In some implementations, each container can be an in-memory column-oriented database. In some implementations, a subset of the total data stored in a database is partitioned and stored in a given container. In some implementations, containers can be further allocated at the object or class level. For example, a database may include a worker table, a journal line table, and various other tables representing objects or classes within an application. In some implementations, the system can ensure that a given container will include only one type of object or class and will include a subset of all records for that object or class.

Since each container can comprise a column-oriented database, each container may store the fields of the objects or classes in a column-oriented manner in memory. In some implementations, each container stores the actual underlying data as well as index data for processing the column-oriented database. In some implementations, the use of column orientation can provide better data management at the field level and can provide optimized query processing for larger datasets. In some implementations, other storage approaches that are not column oriented may be used.

As illustrated in FIG. 2, a query engine 206 is provided to receive queries and generate a result set responsive to the queries. One example of a query is illustrated as SELECT F1, F2, FROM T. In this example, the intent of the query is to generate a result set that includes only the fields F1 and F2 from table T, while excluding all other fields. As can be seen, these types of queries are well suited for column-oriented storage as the fields F1 and F2 are stored contiguously in memory and thus easily accessible. However, since the entire data of table T is distributed across multiple containers the query engine 206 must perform multiple merges of data in order to generate a result set. As illustrated, a first merge 208 retrieves the F1 columns from each container. Next, a second merge 210 retrieve the F2 columns from each container.

In existing systems, the two merges would receive the actual underlying data from each container. Thus, each merge would combine the column portions from each container into a single column for each field. Next, existing systems would then merge the two columns for F1 and F2 to form a result set. As will be discussed, this results in a significant amount of data stored by each container and stored by the query engine when merging. In essence, existing systems require early materialization of subqueries issued to containers. If, however, the query is more complex and includes filtering or aggregation operations this early materialization may be unnecessary.

Thus, the following figures provide an alternative means for processing queries in a distributed database. In brief, each container in the system is configured to return a lightweight pointer-based representation of a column to the query engine. The query engine can be configured to continue executing the query using this lightweight representation until materialization is needed closer to the end of the query. As a result, each container may only materialize the absolute necessary data for the result set and the query engine 206 may only process materialized data that is to be returned as part of the result set. As a result, the entire system uses less storage of materialized data via these lightweight pointers. Further, as will be discussed the query engine can be configured to monitor the materialization process of each container and swap out in memory materialization to disk to avoid out of memory errors when processing the query that results in a large result set.

FIG. 3 is a block diagram illustrating a system for processing distributed queries according to some of the disclosed embodiments.

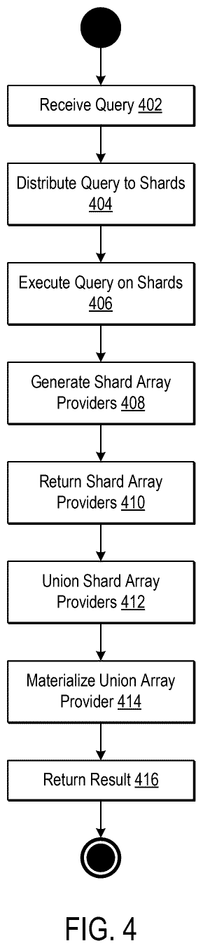

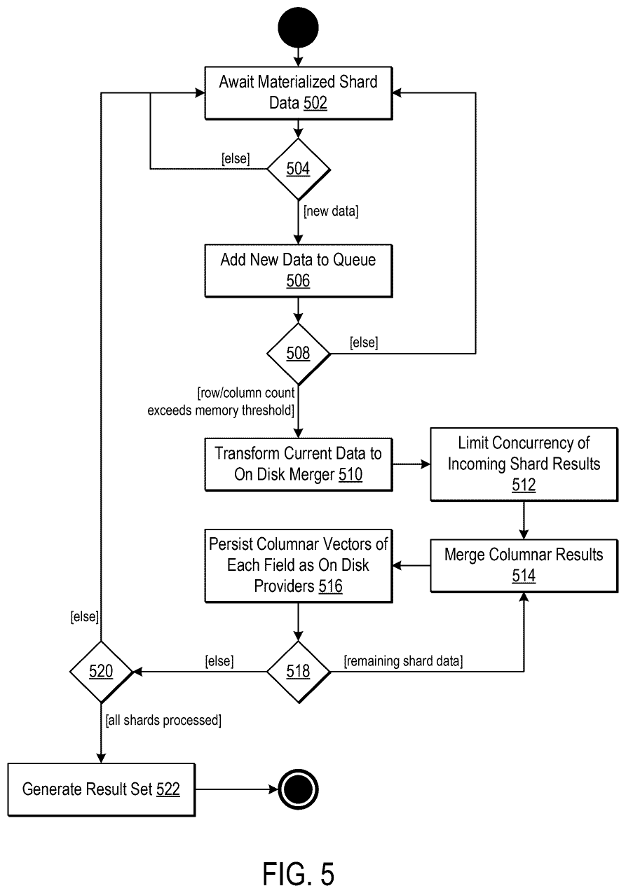

In the illustrated system, a query processing system can receive a query 302 and generate a result set 318. The query 302 is first received by a parser 304 which parses the query 302 and passes the parsed form of the query 302 to a query planner 306 (which may also perform optimization of the query 302). The query planner 306 is communicatively coupled to a plurality of shards (e.g., shard 308A, shard 308B, . . . shard 308N). Each shard includes a query processor (e.g., query processor 310A, query processor 310B, . . . query processor 310N) for processing queries on its portion of a dataset. Each shard also includes an array provider generator (e.g., array provider generator 312A, array provider generator 312B, . . . array provider generator 312N) for building array provider data structures (described in FIG. 4) for the responsive data. The system further includes a materialization manager 314 which manages the individual array providers and creates a union array provider (described in FIG. 4). The materialization manager 314 can further coordinate materialization of data by receiving materialized data from each shared and proactively persisting data to persistent storage 316 while monitoring memory usage (described in FIG. 5). After processing all materialized data, the materialization manager 314 can generate a final result set 318 and return the result set 318 as a response to the query 302.

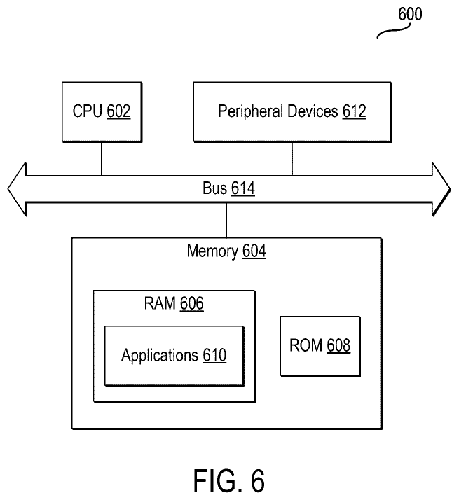

In some implementations, query 302 constitutes the initial input to the query processing system, typically formulated as an SQL statement or similar structured query language input. This query represents the data retrieval or manipulation request from a user or application. In some implementations, the interface receiving query 302 can be hosted on a server or a distributed system capable of network communication, equipped with processors to handle incoming requests and sufficient memory to manage concurrent operations, such as those depicted in FIG. 6. The device handling query 302 may be a server application with network listening capabilities, designed to accept and parse incoming query requests.

In some implementations, parser 304 serves as the initial processing stage for query 302, where the user's request is processed and interpreted. In certain embodiments, parser 304 is a software module equipped with syntax analysis technology capable of deconstructing the SQL statement into its constituent components for further analysis. The software may reside on a server-grade system, which includes multicore processors and high-speed memory, enabling rapid parsing and computational efficiency. The hardware hosting the parser 304 is typically optimized for I/O throughput, ensuring minimal latency in query intake. Additionally, parser 304 could be implemented within a containerized environment or virtual machines as part of a cloud infrastructure, providing scalability and isolated execution contexts for robust query processing.

In some implementations, query planner 306, which may incorporate query optimization functions, takes the parsed query from parser 304 and devises an efficient execution strategy. In some implementations, the query planner 306 can be realized as a software suite that employs advanced algorithms to determine the most efficient way to execute the query across the distributed system. It may consider factors such as data distribution, shard key design, and current system load. The hardware underpinning this component could be composed of high-throughput, low-latency storage systems, such as SSD arrays, to quickly access metadata and data statistics necessary for planning. Additionally, the query planner 306 might leverage multicore CPUs and high-bandwidth memory to parallelize the planning process, especially in complex query scenarios involving multiple joins or sub-queries. This planning and optimization process can also be dynamically adjusted by machine learning models that predict the most efficient query paths based on historical performance data.

A shard, exemplified by shard 308A, represents a discrete subset of the database's total dataset in a distributed database architecture. It is a partition that enables the database to scale horizontally by distributing the load and data across multiple nodes. In some implementations, the physical manifestation of a shard could be a dedicated server or a virtual machine instance, each with its own CPU, memory, and storage resources, configured to handle a segment of the database operations autonomously. The shard operates in conjunction with other shards, but is responsible for a distinct partition of the data, thereby enabling parallel processing of queries and enhancing overall system performance. The software defining a shard's behavior includes database management systems optimized for distributed data storage, and it may use replication, sharding algorithms, and other distribution techniques to ensure data integrity and availability. Additionally, shards can be designed with redundancy and failover capabilities to provide resilience against hardware failures or network issues, ensuring consistent database uptime and reliability.

In some implementations, a shard's query processor is a software component residing within each shard, such as shard 308A, responsible for the execution of the query against its specific subset of the dataset. In certain implementations, this processor is a dedicated service or module, potentially running on a multi-threaded execution environment, which interprets the optimized query plan and carries out the necessary database operations, such as reading, filtering, and computing data. The query processor 310A typically operates on hardware that includes CPUs with high core counts to enable parallel processing of database operations and high-speed RAM to rapidly access and manipulate the data. The software itself can be part of a larger distributed database management system, optimized for the type of data and query workload expected on the shard. It would be equipped with various optimization tools to ensure that data retrieval and manipulation are performed in the most efficient manner possible, according to the distributed system's architecture and the specific performance characteristics of the shard it operates within.

The array provider generator, exemplified by 312A within shard 308A, is a software component for constructing array provider data structures that encapsulate the information necessary to reference and manage the subsets of data responsive to a query. While specific functionalities are detailed in FIG. 4, from a system perspective, this generator is typically a programmatically controlled module designed to interact with the shard's data storage layer. Details of generating array providers is provided in the description of FIG. 5.

In some implementations, materialization manager 314 orchestrates the handling of array providers, managing their lifecycle from creation to the eventual synthesis of a union array provider, as described in FIGS. 4 and 5. The materialization manager 314 functions as a software intermediary, designed to efficiently coordinate the materialization of data, a process where transient, in-memory data structures are converted into persistent storage formats when necessary. Materialization manager 314 can execute on a server or a cluster of servers capable of handling high I/O throughput, facilitating fast data transfer between in-memory and disk-based storage systems. In some implementations, materialization manager 314 intelligently toggles between in-memory and on-disk data handling, utilizing algorithms and thresholds defined in FIG. 5 to ensure data is materialized and persisted only when required, optimizing overall system memory usage and ensuring the timely delivery of query results.

In some implementations, persistent storage 316 represents the hardware and associated software infrastructure where the materialized data is stored for long-term retention. This storage solution is architected to accommodate the high-volume and high-velocity data offloaded by the materialization manager 314. In terms of hardware, persistent storage 316 could comprise solid-state drives (SSDs) for their fast access times, or it may involve more traditional hard disk drives (HDDs) configured in a RAID (Redundant Array of Independent Disks) setup for a balance of speed and redundancy. High-capacity network-attached storage (NAS) or storage area networks (SAN) might also be used, especially when data scalability and network access are priorities.

Functional details of the above system are described more fully in connection with FIGS. 4 and 5 below.

FIG. 4 is a flow diagram illustrating a method for performing lazy materialization of columnar data when executing a query according to some of the disclosed embodiments.

Current in-memory columnar distributed databases may support arbitrary SQL statements. In general, these databases distribute a query to each shard or partition of the in-memory database. a given shard executes the query on its portion of the databases, generates vectors representing the results (e.g., row-oriented vectors), and returns the vectors to the query engine which combines each shards' vectors to form a result set.

Consider, for example, the following SQL query:
SELECT worker_id, worker_org, worker_location FROM worker WHERE <<Filter condition>>;

In an in-memory columnar distributed database, each shard may generate three responsive vectors for each field/column (e.g., Vectorᵢ[worker_id], Vectorᵢ[worker_org], Vectorᵢ[worker_location] for a given shard i). The query engine may then combine these vectors (Vector₁ . . . . Vectorₙ) for n shards to generate a final result set. While this approach returns a valid result, it generates a significant amount of ephemeral data. Specifically, each shard must maintain a number of vectors after executing the query while the query engine must then store all data to generate a final result set by merging the vectors. The following method provides an improvement on executing such queries.

In step 402, the method can include receiving a query.

In some implementations, the query may be an SQL query. In some implementations, the SQL query can include various fields, conditions, and other parameters. Generally, no limit is placed on the supported features of the SQL variant used to generate the query. Indeed, in some implementations, the method may be implemented by a query planner or optimizer which can translate SQL dialects to formats supported by the underlying column-oriented data store.

In step 404, the method can include distributing the query to one or more shards.

As discussed previously, a given dataset from a persistent store can be distributed among a plurality of shards. In some implementations, each shard stores a portion of a class or data type. For example, a table of journal line records may be distributed among a number of shards based on the storage capacity of a given shard, the number of records, and any performance objectives. In some implementations, the method can transmit the received query to each shard. In other implementations, the method can optimize the query and transmit optimized queries to each shard. For example, in some implementations, the method can optimize the query sent to each shard based on the underlying properties of a respective shard. For example, if the SQL query includes a filter requesting a range of records, the method may query a metadata server to identify, based on index data, which shard(s) store the desired records. However, such an optimization may not be necessary.

In step 406, the method can include each shard executing the query on its portion of the dataset.

In some implementations, each shard stores a subset of a class or object type. For example, each shard my include a portion of a database table. As such, when the shard receives an SQL query from the method it can execute the query on its portion of the data. As discussed, in some implementations, the method can optimize a query such that the query issued to a given shard only accesses a single class or object type. For example, join operations can be optimized into individual sub-queries. In some implementations, each shard can execute the SQL query on its portion of the data to identify responsive instances. As will be discussed next, however, the shard will further process its results to prevent the transmission and materialization of the responsive records.

In step 408, the method can include each shard generating one or more array providers based on the type of data returned as a result of executing the query.

In existing systems, a given shard returns the data responsive to an SQL query. Thus, each shard would return a result set of records that are responsive to its share of the SQL query. This providing of actual data in response to a query is referred to as a materialization of the query.

In contrast to returning a result set, in step 406, each shard generates an array provider data structure representing the responsive results. In some implementations, an array provider comprises a custom type that provides all necessary operations for downstream processing of result sets without materializing the actual data responsive to a query. For example, relational operators (e.g., projection) using the field need not materialize the field until it is actually used by an upstream layer.

In some implementations, each field type can be associated with an array provider. Thus, if the SQL query requests two fields as a result, the shard can generate two separate array providers for each field. For example, array providers can be classified as either dimension-backed array providers or measure-backed array providers. In some implementations, dimension-backed providers can be used for categorical fields while measure-backed array providers can be used for numerical fields. In some implementations, both types of fields may include operations that allow for downstream operations without requiring the materialization of the actual data.

For example, dimension-backed array providers may support filtering and grouping operations by referencing metadata or indexes that can resolve these operations using identifiers rather than the full data sets. Similarly, measure-backed array providers could allow for aggregation operations like sum or average to be performed using precomputed summaries or statistical models that represent the underlying data, thereby avoiding the need to access the full detail of the numerical fields until absolutely necessary. This deferred materialization enables the system to operate with a lower memory footprint and improves overall query performance by leveraging the inherent efficiencies of the columnar storage model.

As discussed, in some implementations, each shard can utilize index data to implement the underlying array provider data structures. Specifically, in some implementations, each shard can still execute the query and return an array provider object that includes the responsive id fields of each matching result. Thus, upon executing the SQL query, the shard harnesses these indices to populate the array provider object with identifiers of the records that match the query conditions. Instead of carrying the full weight of the data, this array provider encapsulates a lightweight reference to the subset of data identified by these indices.

Consequently (as will be discussed), when the query engine aggregates the results from all shards, it is aggregating these array provider objects rather than voluminous result sets. This aggregation is inherently efficient, since it deals with references that point to the location of the actual data within each shard's dataset, thus significantly reducing the in-memory data footprint during this phase of query processing.

Moreover, this method allows for a fluid transition to subsequent operations such as joins or further filtering. Since an array provider maintains a direct correlation with the index data, these operations can be executed on the fly by interacting with the index data, which is typically structured to support high-performance read operations. This interaction can be done without the overhead of accessing and manipulating the actual data until these operations are finalized and the data needs to be presented or further processed, offering a strategic advantage in both memory usage and query execution speed.

In step 410, the method can include each shard returning its array providers to a query engine.

Following the execution of the query within individual shards, the method involves each shard sending its respective array providers back to the centralized query engine. The array providers act as compact carriers of information, enabling the shards to communicate their findings to the query engine without transmitting large volumes of data across the system. Instead of sending complete records, shards transmit structured references that allow the query engine to understand where each piece of data can be found.

Upon receipt, and as will be discussed, the query engine then has the task of integrating these disparate pieces of information. It uses the references within the array providers to locate the specific pieces of data across the sharded system that are relevant to the original query. This process is managed in a way that maintains the logical coherence of the dataset, ensuring that related data from different shards is appropriately combined.

Additionally, the use of array providers provides not only efficiency in data transmission but also in processing. The query engine, equipped with these array providers, is prepared to perform further operations on the data, such as merging, sorting, or applying additional filters, all while working with these lightweight references, thereby deferring the need for full data materialization and conserving valuable computational resources.

In step 412, the method can include generating a union of the array providers.

In some implementations, the union of array providers comprises a single, cohesive data structure constructed from the individual array providers returned by each shard. This union array provider can be a composite object that effectively represents the collective dataset of id fields from all shards involved in the query. Generally, the generation of the union array provider does not involve the instantiation of new, intermediate data structures which would otherwise increase memory consumption. Instead, it operates by creating a layer that references the index data already present in each shard's array provider. This allows for a representation of the unionized dataset without the necessity of physically compiling data. The union array provider serves as a virtual map, pointing to the locations of the relevant data across the distributed environment. This virtualization enables the query engine to treat the data as if it were a single dataset, despite it being physically partitioned across multiple shards. The efficiency of this step lies in its deferment of data materialization-only when the final, tangible result set is required is the actual data compiled.

Additionally, this step is designed to work in harmony with pagination techniques. By integrating pagination, the union array provider can manage data in chunks corresponding to the page size, rather than handling the entire dataset at once (as will be discussed in FIG. 5). This can significantly minimize the memory footprint and computational load during the final materialization phase. Pagination allows for a controlled and demand-based materialization of data, where only the necessary portions of the data are materialized as required by the pagination parameters, such as the specific page of results being accessed.

In step 414, the method can include materializing the union.

In this step, a union array provider is transformed into an actual result set. This process translates the abstractions and references held within the union array provider into concrete data. Materialization is executed to consolidate the distributed index data into a structured format, such as rows or records, that can be readily used by applications or end-users. This stage represents the culmination of the query execution, transitioning from a highly efficient, memory-conscious operation into the delivery of tangible query results.

In some implementations, the act of materialization can be performed on-demand, ensuring that memory resources are optimally utilized. It is during this step that the system's ability to defer the full data materialization until absolutely necessary improves the performance of a database system, as it limits the memory-intensive operations to the final stage of the query process. The pagination strategy previously integrated helps to manage and potentially reduce the volume of data being materialized at any one time, further reinforcing the system's efficiency and responsiveness.

In step 416, the method can include returning a result set responsive to the query.

In this step, the method concludes with the return of the result set to the requester, fulfilling the objective of the SQL query. This result set is composed of the fully materialized data that has been synthesized from the distributed shards' contributions. It is at this juncture that the data, once an abstract concept managed by the union array provider, is now presented in a user-consumable format, such as a table of rows and columns, which corresponds to the query parameters defined at the outset.

The delivery of the result set is the final act in the query execution process, providing the end-users or downstream applications with the information queried for. This result set is generated based on the union of data from across the shards, ensuring comprehensive and accurate data retrieval. The efficiency of the entire process, governed by the earlier steps that minimize memory usage and optimize data processing, culminates in this moment, where the query's response is made available, ready for analysis, reporting, or further data operations.

FIG. 5 is a flow diagram illustrating a method for materializing a query result based on array providers according to some of the disclosed embodiments.

The method described herein and depicted in FIG. 5 addresses the challenge of memory consumption in processing extensive columnar data sets by implementing an OnDiskCollectingMerger in tandem with an OnDiskArrayProvider. This pairing works by persisting ephemeral, or temporary, data generated during query execution to disk in a batched manner, thereby reducing the in-memory data footprint. The OnDiskArrayProvider manages references to this persisted data, enabling continuous query processing with the efficiency of in-memory operations while leveraging the scalability of disk storage. The method further optimizes data handling through the use of memory-mapped files for rapid access, data compression for storage efficiency, and encryption for security. Initially applied to top-level query projections to enhance memory management, this method also incorporates pagination, significantly reducing the memory demands of constructing result sets. The approach is designed to be extensible to more complex query functions, promising a versatile solution to the memory overhead challenges inherent in large-scale data analysis.

In step 502, the method can include waiting for materialized shard data. In some implementations, the materialized shard data comprises the underlying data represented by an array provider generated by a shard.

In step 502, materialized shard data refers to data that has been processed and is represented by an array provider that a specific shard generated. The array provider acts as an intermediary, holding references to the actual data which has been queried and processed by that shard. This step accounts for the variability in processing times across different shards, due to factors such as varying data size, shard performance, and network latency. The system remains in this waiting state until a notification of new data availability is received from a given shard, ensuring that the method proceeds with up-to-date information from each shard.

In step 504, the method can include determining when new materialized data is received from a given shard. While no data is received, the method returns to step 502 and can wait longer for new data.

In some implementations, the method can actively monitor for the reception of new materialized data from each shard. Upon the arrival of such data, the method acknowledges its receipt, which triggers subsequent steps. If no new data is detected, the method reverts to the waiting state outlined in step 502, ensuring readiness to promptly respond once the materialized data becomes available.

In step 506, the method can include adding the new shard data to a queue.

In some implementations, the queue acts as a buffer, collecting and ordering the data as it arrives from the shards. Constructing such a queue can include initializing a data structure that supports first-in-first-out (FIFO) operations, where the earliest received data is processed first. This ensures that data is processed in the order of arrival, which can be important for maintaining the integrity and sequence of the result set. In some implementations, the queue is maintained by enqueuing new data at the tail and dequeuing data from the head when it's ready to be processed. The system must also handle potential issues such as concurrency control, where multiple shards might deliver data simultaneously, and queue capacity, to prevent memory overflow.

Although a queue is used, other data structures could be used instead of a standard queue. As one example, a priority queue can be used if certain shards' data is prioritized (e.g., based on data size or shard importance). As another example, a circular buffer or stack can be used. As another example, binary heap can be used if the data needs to be accessed in a specific order that isn't strictly FIFO. In some implementations, the choice of data structure would depend on the specific requirements of the query processing system, such as the need for sorting, the expected volume of data, and the complexity of data management operations. In some implementations, the queue or equivalent data structure can be stored in-memory until ready for persistence according to the following steps.

In step 508, the method can include determining if the row count and column field count of the materialized data breaches a memory threshold limit. If not, the method can include returning to step 502 where it continues to await new shard data. If, however, the row and column field count of the materialized data breaches the memory threshold limit the method can proceed to step 510.

In step 508, the method evaluates the volume of accumulated materialized data against predefined memory capacity constraints. This step is designed to prevent system overload by monitoring at least two metrics: the row count and the column field count of the materialized data currently held in the queue. The row count pertains to the number of individual records, while the column field count relates to the number of distinct data fields present within those records. Together, these counts provide a measure of the data's memory footprint. The method sets a memory threshold limit-a specific value that the combined size of the row count and column field count should not exceed to maintain desired system performance and prevent memory exhaustion. If the current counts are within safe limits, the method returns to step 502, signifying that the system can safely accommodate more materialized data. Conversely, if the threshold is breached, indicating that the queued data has reached a potentially critical memory usage level, the method advances to step 510.

In some implementations, the threshold limit acts as a safeguard against the potential risk of in-memory data growing to an unmanageable size, which could impede system performance or even lead to failures such as out of memory errors. By dynamically monitoring and responding to these counts, the system ensures that it remains within operational memory limits while preparing to initiate the next phase of data handling, which includes persisting data to disk to alleviate memory pressure.

In step 510, the method can include transforming the current shard data stored within the queue into an OnDiskMerger.

In this step, the queued data is converted to an OnDiskMerger structure. In some implementations, the OnDiskMerger is a data structure specifically designed to manage and facilitate the transition of data from a volatile in-memory state to a stable, persisted state on disk. This step is activated when the in-memory queue reaches its capacity limits, as determined in step 508. In some implementations, as shard data is added to the OnDiskMerger, it batches the data and begins the process of persisting it to disk. In some implementations, the OnDiskMerger acts as a coordinating data structure, ensuring that the data is written to secondary storage in an organized and retrievable manner, maintaining the logical structure necessary for subsequent query processing steps.

In some implementations, the OnDiskMerger can provider operations including sorting, compression, and encryption of the data as it is written. In general, the OnDiskMerger is configured to handle large volumes of data without compromising on the performance benefits of in-memory operations.

In step 512, the method can include setting a limit on the concurrency of incoming shard data.

As the method detects a breach of the memory limit reached by engaging the OnDiskMerger, the method can proactively regulate the flow of incoming data to ensure stability during this transition. In some implementations, the method can set a concurrency limit on the inflow of shard data. In some implementations, this limit is a control measure to prevent an overload of the system's input buffer, which could lead to a bottleneck situation as the method begins to offload data to disk. In some implementations, the establishment of this concurrency limit serves to moderate the rate at which the system accepts new data, aligning it with the speed of the OnDiskMerger's processing capabilities. By doing so, the system maintains an equilibrium between data inflow and outflow, ensuring that the transition to disk storage does not create a backlog that the in-memory structures can no longer handle. This regulation is useful to avoid compounding the memory usage issue and to ensure a smooth, controlled process as the system engages its on-disk data management strategy.

In step 514, the method can include merging the columnar results up to a certain batch of rows.

In this step, the method consolidates the columnar data that has been accumulating from different shards. In some implementations, merging the columnar results refers to the process of integrating the data from the various array providers, each representing a column's data from a shard, into a unified format. This is done in preparation for creating a coherent result set that can be operated on or returned in response to the query (described herein). In some implementations, the merging process processes the persisted data in such a way that the relationships between different columns and rows are correctly maintained.

In some implementations, the merging process can be conducted in discrete segments or batches. Rather than attempting to merge all available data at once—which could be overwhelming in terms of memory and processing requirements—the method handles a manageable subset of rows at a time. This batching approach allows the system to process data incrementally and helps manage memory usage effectively by limiting the amount of data being actively merged and held in memory. As such, in some implementations, the method can include combining data batches until all the relevant data has been processed. In some implementations, the batches can be determined by the system based on the optimal number of rows that can be merged without exceeding memory constraints, ensuring that the system can continue to operate efficiently even as it processes potentially large volumes of data.

In step 516, the method can include persisting columnar vectors for each field and creating on disk providers for the vectors.

In this step, the method commits the columnar data to a durable medium by persisting it onto disk. In some implementations, each vector refers to an array-like structure that holds the data for a single field across multiple rows. For example, all the values of a worker_id column from a query forms one vector, while the values from a worker_org column form another, and so on. These vectors encapsulate the columnar nature of the data, maintaining its structure and enabling efficient access patterns, particularly for analytical and read-intensive operations.

In some implementations, the OnDiskProvider comprises specialized component that serves as an intermediary between the in-memory operations and the physical disk storage. As each vector is persisted, an OnDiskProvider is created for it. This OnDiskProvider does not simply represent a static file on disk; rather, it is an active entity that maintains a reference to the location of the persisted data and understands how to interact with it. It provides a set of operations that allow the system to work with the data as if it were still in memory, such as reading and writing operations, while actually interfacing with the disk-based data.

This process signifies a shift from transient, in-memory data management to a more persistent state, ensuring that the system's memory is not unduly taxed and that the data remains accessible for the duration of the query operation. The OnDiskProviders enable the system to treat disk-resident data with the same flexibility and efficiency as in-memory data, thus blurring the lines between the two and enhancing the system's overall capacity to handle large datasets.

As the OnDiskMerger transitions to persisting columnar data, an mmap (memory-mapped file) approach can be employed. This technique allows for rapid access to the stored data upon subsequent reads, enhancing retrieval speeds. Additionally, to optimize storage utilization and secure the persisted data, compression algorithms can be applied, and tenanted encryption can be implemented. The encryption ensures that data at rest is protected, and it is decrypted seamlessly during read operations to maintain data integrity and security.

In some implementations, the method can utilize an Apache® Arrow-based approach for columnar data persistence. However, to leverage advanced capabilities such as data compression and tenanted encryption, other approaches may be used such as using memory-mapped files (mmap) via Java's NIO or NIO.2 API.

In step 518, the method can include determining if there is any remaining shard data in the queue. If so, the method returns to step 514 where it can merge the columnar results and, in step 516, persist the columnar vectors and create on disk providers. Alternatively, when the method determines that all shard data has been persisted, the method proceeds to step 520.

In the above steps, the method can include assessing the progress of data processing by checking for any remaining shard data in the queue. If there is data yet to be processed, the system cycles back to step 514 to continue merging these results. This cyclical process ensures that each batch of data is handled consistently and merged into a unified format and then persisted along with the creation of corresponding OnDiskProviders as outlined in step 516. This loop continues until the queue is empty, indicating that all the shard data has undergone the merging and persisting processes. At this stage, with the assurance that all the data from the shards has been successfully transformed and stored, the method advances to step 520.

In step 520, the method can include determining if all shards have finished processing and returning their data. If not, the method can return to step 502 and continues processing data returned from shards until all responsive data has been received. If all shards have been processed, the method can alternatively proceed to step 522.

In this second check, the method monitors the overall progression of the data processing across all shards responsive to a query. It checks to confirm whether each shard has completed its assigned processing tasks and has sent back the processed data. If any shards are still executing their queries or there is data yet to be returned, the method reverts to step 502, ensuring the collection and processing of shard data continues seamlessly. This is a loop until all data from all shards has been duly received, indicating that the distributed part of the query execution is complete. Once confirmation is received that all shards have finished their processing and all the data has been returned, the method moves forward to step 522.

In step 522, the method can include generating a result set based on the on disk providers.

This step can leverage the OnDiskProviders, which by now represent all the data that has been merged, batched, and persisted to disk from the various shards. The OnDiskProviders are tasked with facilitating the assembly of this data into a cohesive result set that is structured according to the original query's requirements. The generation of the result set from the OnDiskProviders involves collating the data referenced by these providers into a format suitable for the end-user or application-typically rows and columns in SQL queries. This step translates the data from a state optimized for on-disk storage back into a form that can be easily interpreted and utilized by the querying entity. The OnDiskProviders ensure that this translation is efficient and that the integrity of the data is maintained throughout the process. They provide a bridge between the persisted data and the in-memory structures necessary for creating the final result set, allowing the system to deliver the query's results with the expected performance benefits of in-memory operations despite the data residing on disk. In some implementations, the method can further provide support for paginated access to the disk-based results.

In some implementations, the files persisted on disk can be transient, their relevance confined to the duration of the query execution session. Upon delivery of the final results to the requestor, the method can initiate a cleanup process, purging these temporary files to reclaim storage space and prevent data residue. This deletion process can ensure the system's state is reset post-query execution. Moreover, an additional cleanup routine is executed during system startup to ensure a clean state. This preemptive measure guarantees that each query execution commences in a pristine environment, free from any potential data carryover from previous operations.

In some implementations, the above process may be synchronous, necessitating that the client's thread remains idle while awaiting the completion of the query, with an associated timeout to manage execution length. This synchronous approach can be selectively applied to queries that are expected to finish within this constrained timeframe, particularly those that demand extensive runtime memory resources. In other implementations, the method can be extended to include support for a broader range of operators within this synchronous framework. In such implementations, the method can adopt asynchronous query execution, which would allow client threads to proceed with other tasks while the query runs in the background, thereby enhancing system efficiency and user experience.

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. a display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. a haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. a GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a processor, a query from a client device;
distributing, by the processor, the query to a plurality of shards;
receiving, by the processor, a plurality of array provider data structures from the plurality of shards, a given array provider data structure identifying responsive identifiers from a corresponding shard;
materializing, by the processor, the plurality of array provider data structures;
persisting, by the processor, a portion of responsive data on disk while materializing the plurality of array provider data structures;
merging, by the processor, data stored on the disk; and
returning, by the processor, a result set based on the data to the client device.

2. The method of claim 1, wherein the given array provider data structure stores an array of responsive record identifiers.

3. The method of claim 2, wherein the given array provider data structure supports at least one operation on the array of responsive record identifiers.

4. The method of claim 3, wherein the given array provider data structure comprises one of a dimension-backed array provider or a measure-backed array provider.

5. The method of claim 1, wherein persisting a portion of responsive data on disk while materializing the plurality of array provider data structures comprises:
monitoring, by the processor, memory usage while receiving the responsive data;
detecting, by the processor, that an amount of used memory is at or exceeds a threshold; and
copying, by the processor, the responsive data from a queue to a persistent storage device.

6. The method of claim 5, further comprising limiting a concurrency of incoming data from the plurality of shards while copying the responsive data.

7. The method of claim 5, wherein copying the responsive data comprises persisting the responsive data as on disk provider data structures.

8. A non-transitory computer-readable storage medium for tangibly storing computer program instructions capable of being executed by a processor, the computer program instructions defining steps of:
receiving, by the processor, a query from a client device;
distributing, by the processor, the query to a plurality of shards;
receiving, by the processor, a plurality of array provider data structures from the plurality of shards, a given array provider data structure identifying responsive identifiers from a corresponding shard;
materializing, by the processor, the plurality of array provider data structures;
persisting, by the processor, a portion of responsive data on disk while materializing the plurality of array provider data structures;
merging, by the processor, data stored on the disk; and
returning, by the processor, a result set based on the data to the client device.

9. The non-transitory computer-readable storage medium of claim 8, wherein the given array provider data structure stores an array of responsive record identifiers.

10. The non-transitory computer-readable storage medium of claim 9, wherein the given array provider data structure supports at least one operation on the array of responsive record identifiers.

11. The non-transitory computer-readable storage medium of claim 10, wherein the given array provider data structure comprises one of a dimension-backed array provider or a measure-backed array provider.

12. The non-transitory computer-readable storage medium of claim 8, wherein persisting a portion of responsive data on disk while materializing the plurality of array provider data structures comprises:
monitoring, by the processor, memory usage while receiving the responsive data;
detecting, by the processor, that an amount of used memory is at or exceeds a threshold; and
copying, by the processor, the responsive data from a queue to a persistent storage device.

13. The non-transitory computer-readable storage medium of claim 12, further comprising limiting a concurrency of incoming data from the plurality of shards while copying the responsive data.

14. The non-transitory computer-readable storage medium of claim 12, wherein copying the responsive data comprises persisting the responsive data as on disk provider data structures.

15. A device comprising:
a processor configured to:
receive a query from a client device;
distribute the query to a plurality of shards;
receive a plurality of array provider data structures from the plurality of shards, a given array provider data structure identifying responsive identifiers from a corresponding shard;
materialize the plurality of array provider data structures;
persist a portion of responsive data on disk while materializing the plurality of array provider data structures;
merge data stored on the disk; and
return a result set based on the data to the client device.

16. The device of claim 15, wherein the given array provider data structure stores an array of responsive record identifiers and supports at least one operation on the array of responsive record identifiers.

17. The device of claim 16, wherein the given array provider data structure comprises one of a dimension-backed array provider or a measure-backed array provider.

18. The device of claim 15, wherein persisting a portion of responsive data on disk while materializing the plurality of array provider data structures comprises:
monitoring, by the processor, memory usage while receiving the responsive data;
detecting, by the processor, that an amount of used memory is at or exceeds a threshold; and
copying, by the processor, the responsive data from a queue to a persistent storage device.

19. The device of claim 18, further comprising limiting a concurrency of incoming data from the plurality of shards while copying the responsive data.

20. The device of claim 18, wherein copying the responsive data comprises persisting the responsive data as on disk provider data structures.
